(19) United States
(12) Patent Application Publication
(10) Pub. No.: US 2006/0099302 A1
(43) Pub. Date: May 11, 2006

(54) Process for treating pectin containing plant material

(75) Inventor: Jan Aa Staunstrup Christensen, Bronshoj (DK)

Correspondence Address: David M Goodrich;J M Huber Corporation, 333 Thornall Street, Edison, NJ, 08837-2220, US

(73) Assignee: CP Kelco APS, Lille, Skensved (DK)

(21) Appl. No.: 10/525,659

(22) PCT Filed: Sep. 2, 2003
(86) PCT No.: PCT/DK03/00570

§ 371 Date: Aug. 22, 2005

(30) Foreign Application Priority Data
Sep. 2, 2002 (DK) PA 2002 01280

(51) Int. Cl. A23B 7/10

(52) U.S. Cl. 426/50

(57) ABSTRACT

The present invention discloses a method for treating pectin containing plant material. The fresh plant material is adjusted to a pH between 3.2 and 3.9 at a temperature below 90° C. to render the native pectin esterase in the plant material inactive. Thus, minimal deesterification takes place during transportation of the plant material, nor during subsequent washing and/or conventional drying of the plant material. Since the enzyme remains inactivated, the activity of the enzyme can be re-established at a later point by increasing the pH to above about 4.0. Pectin made from such treated plant material has a higher molecular weight and a lower calcium sensitivity than pectin made from the same plant material, which has not been subjected to said treatment.

### FIELD OF THE INVENTION

The present invention relates to an improved method of treating a pectin containing starting material to reduce or to avoid chemical and/or enzymatic and/or microbiological changes of the pectin contained in said pectin containing starting material.

### BACKGROUND OF THE INVENTION AND RELATED INFORMATION

Pectin is a complex polysaccharide associated with plant cell walls. It consists of an alpha 1-4 linked polygalacturonic acid backbone intervened by rhamnose residues and modified with neutral sugar side chains and non-sugar components such as acetyl, methyl, and ferulic acid groups.

The neutral sugar side chains, which include arabinan and arabinogalactans, are attached to the rhamnose residues in the backbone. The rhamnose residues tend to cluster together on the backbone. So, with the side chains attached this region is referred to as the hairy region and the rest of the backbone is hence named the smooth region.

In U.S. Pat. No. 5,929,051, Ni, et al. describes pectin as a plant cell wall component. The cell wall is divided into three layers, middle lamella, primary, and secondary cell wall. The middle lamella is the richest in pectin. Pectins are produced and deposited during cell wall growth. Pectins are particularly abundant in soft plant tissues under conditions of fast growth and high moisture content. In cell walls, pectins are present in the form of a calcium complex. The involvement of calcium cross-linking is substantiated by the fact that chelating agents facilitate the release of pectin from cell walls as disclosed by Nanji (U.S. Pat. No. 1,634,879) and Maclay (U.S. Pat. No. 2,375,376).

According to Dumitriu, S.: Polysaccharides, Structural diversity and functional versatility, Marcel Dekker, Inc., New York, 1998, 416-419, pectin is used in a range of food products.

Historically, pectin has mainly been used as a gelling agent for jam or similar, fruit-containing, or fruit-flavored, sugar-rich systems. Examples are traditional jams, jams with reduced sugar content, clear jellies, fruit-flavored confectionery gels, non-fruit-flavored confectionery gels, heat-reversible glazing for the bakery industry, heat-resistant jams for the bakery industry, ripples for use in ice cream, and fruit preparations for yogurt.

A substantial portion of pectin is today used for stabilization of low-pH milk drinks, including fermented drinks and mixtures of fruit juice and milk.

The galacturonic acid residues in pectin are partly esterified and present as the methyl ester. The degree of esterification is defined as the percentage of carboxyl groups esterified. Pectin with a degree of esterification (“DE”) above 50% is named high methyl ester (“HM”) pectin or high ester pectin and one with a DE lower than 50% is referred to as low methyl ester (“LM”) pectin or low ester pectin. Most pectin found in plant material such as fruits, vegetables and eelgrass are HM pectins. Acetate ester groups may further occur at carbon-2 or -3 of the galacturonic acid residues. The degree of acetate esterification (“DAc”) is defined as the percentage of galacturonic acid residues containing an acetate ester group. Most native pectins have a low DAc, one exception being sugar beet pectin.

Pectins are soluble in water and insoluble in most organic solvents. Pectins with a very low level of methyl-esterification and pectic acids are for practical purposes only soluble as the potassium or sodium salts.

Pectins are most stable at pH 3-4. Below pH 3, methoxyl and acetyl groups and neutral sugar side chains are removed. At elevated temperatures, these reactions are accelerated and cleavage of glycosidic bonds in the galacturonan backbone occurs. Under neutral and alkaline conditions, methyl ester groups are saponified and the polygalacturonan backbone breaks through beta-elimination-cleavage of glycosidic bonds at the non-reducing ends of methoxylated galacturonic acid residues. These reactions also proceed faster with increasing temperature. Pectic acids and LM pectins are resistant to neutral and alkaline conditions since there are no or only limited numbers of methyl ester groups.

According to Kertesz, Z. I: The Pectic Substances, Interscience Publishers, Inc, New York, 1951, pectic materials occur in all plant tissues. However, of industrial importance are particularly apples, beets, flax, grapefruit, lemons, limes, oranges, potatoes, and sunflower. Lately, also the pectin in Aloe vera has shown industrial utility.

In U.S. Pat. No. 1,513,615, Leo discloses an enzymatic process for solubilization of protopectin. He observes that pectase does not work when acid is present. Consequently, he breaks up the fruit cells by cooking in water and then he adds calcium carbonate after which he adds pectase. Thus, Leo increases the pH to a point where pectase is active in order to avoid the use of acid in the subsequent extraction.

In U.S. Pat. No. 1,497,884, Jameson sets out to solve the problem that peel contains pectinase, which removes methyl groups on the pectin. When pectinase is present, the pectin loses methyl groups and this leads to lower gel power. He solves the problem by first chopping the peel and then destroying the pectinase by heating the chopped peel to just below 100° C. for no more than 10 minutes.

In U.S. Pat. No. 1,654,131, Leo inactivates enzymes in the peel be treating peel cut into slices or pieces with strong alcohol such as 95% ethanol. In this way he solves the problem of reduces gel power of pectin when the peel is dried in the presence of acids and enzymes. Leo uses the fact that alcohol denatures proteins such as enzymes, but he does not utilize any effect on the enzymes through a reduction of pH.

In U.S. Pat. No. 2,020,572, Platt uses the same principle as in U.S. Pat. No. 1,497,884 and treats finely ground peel with heat in order to destroy enzymes.

In U.S. Pat. No. 2,165,902, Myers solves the problem that conventional kiln drying of peel does not heat the peel quickly enough to inactivate enzymes. He does that by leaching ground fresh peel with a solution of copper sulfate heated sufficiently to inactivate pectinase.

In U.S. Pat. No. 2,323,483, Myers inactivates enzymes in fresh peel by washing the ground fresh peel in water at 90° C. for 5 minutes.

In U.S. Pat. No. 2,358,430, Willaman discloses a process for enzymatic deesterification of pectin. He treats a pectin dispersion with pectase at pH 6.0 and at a temperature, which is favorable for pectase. That temperature is 40-45° C., and after a certain time in which the pH is maintained at 6.0, the reaction is stopped by heating to 70-80° C. or by lowering the pH to 3-4 and then heating. Willaman sets out to solve the problem that conventional methods for deesterification of pectin, i.e. at that time alkali deesterification, result in reduced gel power of the resulting deesterified pectin. He does that by letting the enzyme pectase do the deesterification on the pectin.

In U.S. Pat. No. 2,444,266, Owens discloses a process for making a series of partially demethoxylated pectins of high molecular weight by letting native enzyme from citrus peel or apple pomace react on the pectin before extraction. He emphasizes that the peel must not have been treated to inactivate the enzyme.

In U.S. Pat. No. 2,387,635, Bailey discloses a process for preparing pectin-bearing plant material for extraction of pectin. The method involves removal of soluble solid constituents prior to extraction. The process comprises the steps of adjusting the pH to 2.8-3.5, heating the pectous source material to about 90 C for about 10 minutes, cooling the material to about 37-40 C, adding and growing therein a yeast, thereby breaking down the non-pectous carbohydrate substances, adjusting the pH of the fermented mass to about 2.9 and heating and subsequently recovering pectin. The initial heating inactivates any enzymes and microorganisms present. The fermentation removes sugars and other unwanted soluble solids.

In GB A 453877, a procedure for the treatment of a plant material containing pectin is disclosed. The plant material is treated with an organic or inorganic acid before extraction of pectin without damaging the gelling ability of the pectin. The procedure results in an altered gelling capacity in the resultant pectin. The pH is kept at 0.1-2.5 during the treatment.

In U.S. Pat. No. 5,567,462, a procedure for the preparation of a pecto-cellulosic composition is disclosed wherein comminuted citrus peel or other pectin-containing material is treated with an acidified aqueous solution to solubilize the pectin. U.S. Pat. No. 5,567,462 teaches the use of acids ranging in pH from 1 to 3.3 to solubilize the pectin.

In JP A 59-096105, a procedure for obtaining high-quality pectin in good yields is disclosed. In this process, a mineral acid solution of at least 0.01N (i.e. a pH of approximately 0.3-2) is disclosed as a limit on the solubilization of pectin.

In JP A 61-085402, a process for producing a high-quality pectin in high yields by contacting dry pectin containing plant material with an acid at a temperature below 10 C prior to extraction is disclosed. The acids disclosed are inorganic acids at a strength of 0.5-5.0N (i.e. a pH of approximately 0.1-0.3).

In summary, the prior art has dealt with the problems of enzymes in the peel. However, these enzymes have been viewed as a problem and not as an opportunity. Thus, for the most part the native enzymes have been destroyed through the use of heat. In fact, the prior art states that traditional kiln drying is not sufficient to destroy the enzyme, and consequently a prior heating in an aqueous system is needed. Another approach involves the use of ethanol to destroy the enzymes before drying the peel. This method, however, is hazardous because of the potential risk of an explosion. The utilization of native enzymes in peel to deesterify pectin is known. However, the principle is either used on pectin having been extracted, or the principle is used on fresh peel.

Consequently, there is a need to make a dry pectin containing starting material in which the native enzymes have been rendered inactivated, so that they do not change the composition of the pectin in the fresh peel during transportation and during drying. Also, the enzymes must be inactivated in the dry peel during storage. However, once the dry peel is to be extracted, the enzymes should once again become active so that an in situ deesterification in the peel can be accomplished before extraction of the pectin.

### SUMMARY OF THE INVENTION

It has now surprisingly been discovered that when fresh peel is adjusted to a pH between 3.2 and 3.9 at a temperature below 90° C., the native pectin esterase in the peel becomes inactivated. Thus, minimal deesterification takes place during transportation of the fresh peel and during subsequent washing and/or conventional drying of the fresh peel. Since the enzyme remains inactivated, the activity of the enzyme can be re-established at a later point by increasing the pH to above about 4.0.

### DETAILED DESCRIPTION OF THE INVENTION

The present invention relates to an improved method of treating a pectin containing plant starting material before extracting the pectin from the pectin containing plant starting material.

The pectin containing plant starting material may be any material containing pectin. Such materials include citrus fruits, other fruits such as apples, beets, remains from the manufacturing of soy protein, linseed or flax, aloe, sunflower buttons, etc. The present invention is particularly useful for treating pectin containing plant starting material, which inherently have a pH above 4. Examples of such plant materials are orange, grape fruit, fodder beet, sugar beet and carrots.

The present invention comprises a method for treating such plant material, the resulting pectin made by subsequent extraction of treated pectin containing plant starting material and the uses of said pectin.

The method involves the following steps: As soon as possible after the pectin containing plant starting material has been physically handled, for instance pressed, the remains, for instance the citrus peel, the lamellae and the juice sacks, are treated with acidified water. If this is not feasible, the treatment of the pectin containing plant starting material should take place as soon after a fresh water washing of the pectin containing plant starting material as possible. The pectin containing plant starting material may be treated as it comes or the pectin containing plant starting material may be ground or sliced to improve the treatment. The pH of the acidified water may vary in the range of 3.2-3.9 and more preferably within the pH range of 3.4-3.7. At pH values below about 3.2, the pectin will solubilize, which is undesired. At pH values about 4 and above, on the other hand, the native pectin esterase becomes active and starts de-esterification and degradation of the pectin. The treatment with acidified water, or wash with acidified water, can be performed in a batch wise fashion or in a continuous fashion. In a batch wise washing process, one or more washing steps can be used to remove as much soluble material such as sugar as possible. Although more than three washing steps can be used to remove even more solutes, three washing steps produce an acceptable level of solutes without increasing the cost unacceptably. In a continuous washing process, the acid is added at the end of the washing line, where the natural acids if present in the pectin containing plant starting material has the lowest concentration. Such continuous counter current washing techniques are well known in the art.

The acid used in the present invention can be any inorganic and any organic acid capable of reducing the pH in the pectin containing plant starting material to the desired pH. Examples of inorganic acids include hydrochloric acid, sulfuric acid, sulfur dioxide, nitric acid, etc and examples of organic acid include citric acid, oxalic acid, acetic acid, etc. Another means of achieving the desired pH of the pectin containing plant starting material is to use a buffer solution instead of acid. Examples of buffer solutions include:

| | Useful buffering |
|---|---|
| Chemicals | range at 25° C. |
| Hydrochloric acid/disodiumhydrogencitrate | 2.0-4.0 |
| Glycine/Hydrochloric acid | 2.2-3.6 |
| Potassium hydrogen phthalate/Hydrochloric | 2.2-4.0 |
| acid | |
| Citric acid/Sodium citrate | 3.0-6.2 |
| Sodium acetate/Acetic acid | 3.7-5.6 |

To avoid extraction of the pectin contained in the pectin containing plant starting material, washing with acidified water must take place at temperatures below 90° C., preferably below 50° C. and most preferably below 35° C. For practical purposes, the washing with acidified water would take place at the temperature of the water at hand, which in most cases would be between 10° C. and 30° C., but lower temperatures of the acidified water can be used as well.

When using a batch wise washing process, it is convenient to lightly press the washed pectin containing plant starting material between each wash to ensure the best possible removal of solutes. The pressing should be done in such a manner that the pectin containing plant starting material is only pressed free of excess liquid, not in a manner, which causes the pectin containing plant starting material to be crushed in such a way as to present separation and/or drying difficulties later in the process.

The time, during which the pectin containing plant starting material is washed with acidified water must be sufficient to effectively reduce the pH in the pectin containing plant starting material to a pH within the range of 3.2-3.9 and more preferably within the pH range of 3.4-3.7. This time is typically in the range 5-60 minutes per washing step, preferably 5-30 minutes per washing step and most preferably 10-20 minutes per washing step. Longer washing times are possible, but do not provide any extra benefits.

After the washing with acidified water, the plant esterase activity in the treated pectin containing plant starting material is inactive or inactivated. Thus, the plant esterase, which naturally occurs in the pectin containing plant starting material, no longer performs its deesterification effect on the pectin contained in the pectin containing plant starting material. Thus, the treated pectin containing plant starting material can be stored or transported without the pectin contained in the pectin containing plant starting material being deesterified. This is important because the plant esterase deesterifies the pectin in the pectin containing plant starting material in a block wise fashion, which renders the resulting pectin more calcium sensitive. In addition, by preventing blocks of carboxyl acid groups, the risk of depolymerization during a subsequent drying and extraction at high temperatures is minimized. By inactivating the plant esterase, the pectin remains unchanged. The pectin in the treated pectin containing plant starting material may subsequently be extracted according to known methods.

The treated pectin containing plant starting material may also be used for immediate extraction according to known art. Alternatively, the treated pectin containing plant starting material may be dried and optionally milled before the pectin is extracted from the dried treated pectin containing plant starting material. This option is particularly useful when the treatment operation and the extraction operation are located far apart, and when transportation of the wet treated peel is impractical. The present invention is particularly useful when the treated pectin containing plant starting material is subsequently dried. Drying may take place in any known manner with or without vacuum. A drying temperature of less than 80° C. is recommended to avoid creating a solid coating on the surface of the pectin containing plant starting material. Since the plant esterase has been rendered inactivated and stays inactivated during the drying step, the disadvantage of known principles of drying pectin containing plant starting material containing pectin is avoided. During the conventional drying, in which the plant esterase is not inactivated, the slow heating during drying leads to severe deesterification, which the present invention avoids.

However, the present invention also offers the possibility of reactivating the plant esterase, so that block wise deesterification can take place in the wet or dry acid washed pectin containing plant starting material prior to extraction. This is accomplished by spraying the wet or dry acid washed pectin containing plant starting material with a solution of alkali, such as diluted sodium hydroxide or any other suitable alkali to increase the pH of the pectin containing plant starting material to above 4.0, preferably to 4.5-6.0 and most preferably to 4.5-5.5. Alternatively, the wet or dried acid washed pectin containing plant starting material may be suspended in the said dilute alkali. The temperature is chosen as the optimum temperature of the plant esterase, which is in the range 40-80° C., preferably 50-70° C. and most preferably 60-70° C., and the time is chosen to reach the desired blocky deesterification. Depending on the temperature, the time ranges from about 1 hour at high temperatures to several hours at the lower temperatures.

The present invention also relates to the pectin extracted from the treated pectin containing plant starting material. Thus, treating the pectin containing plant starting material according to the present invention results in pectin with low calcium sensitivity. In fact, the calcium sensitivity, when measured as the ratio of the break strength between a gel made with calcium ions added and a gel made without calcium ions added is in the range 0.90-1.40, preferably 0.90-1.20 and most preferably 0.90-1.10. This improvement of calcium sensitivity is particularly useful for pectin made from orange, grapefruit and beet.

In addition, said pectin is of a higher molecular weight than pectin, which has not undergone the treatment of the present invention. The molecular weight is increased by up to 50%, often by 10-40% and usually by 15-30%. The increase in molecular weight is particularly pronounced when orange, grapefruit and beet are used.

Further, the traditional USA SAG (re definition thereof, see below) of the pectin is increased. By treating pectin containing plant starting material according to the present invention, the USA SAG is increased by up to 30%, more often by 5-25% and usually by 10-20%. The increase in USA SAG is particularly pronounced when using orange, grapefruit and beet.

The present invention also relates to the use of the treated pectin containing plant starting material in the manufacture of pectin, in the manufacture of animal feed and for use in foodstuffs.

The present invention also relates to the uses of said pectin. Uses include foodstuffs, cosmetic products, pharmaceutical products and household products. The pectin according to the present invention is particularly useful for making jams and jellies, for bakery products including jams and dough, whether laminated or not, acidified protein beverages, wound care preparations, ostomy products etc.

Materials and Methods

Extraction of Pectin

In this application, pectin is extracted using the following steps:
1. 15 liters of water is heated to 70° C. in a stainless steel, jacketed vessel having a volume of 18 liters and equipped with a stirrer.
2. 500 g peel are added to the water, and the pH is adjusted to 1.7-1.8 by addition of 62% nitric acid.
3. Extraction is carried out at 70° C. for 7 hours while stirring.
4. After extraction, the content of the vessel is filtered on a Bücher funnel using diatomaceous earth as filter aid.
5. The filtered extract is ion exchanged while stirring by adding 50 ml resin (Amberlite SR1L, produced by Rohm&Haas) per liter of filtered extract. While stirring, the ion exchange is carried out during 20 minutes while stirring.
6. The ion exchanged filtrate is filtered on a Bücher funnel equipped with a cloth.
7. The filtered ion exchanged filtrate is precipitated by adding it to three parts of 80% isopropanol while stirring gently.
8. The precipitate is collected on nylon cloth and pressed by hand to remove as much isopropanol as possible.
9. The hand pressed precipitate is washed once in 60% isopropanol and then dried at 70° C. in a drying cabinet at atmospheric pressure.
10. After drying, the pectin is milled.

Breaking Strength and IPPA Temperature at 65% SS for EM-Pectin (Slow Set)

Principle

Breaking strength is measured on Texture Analyser (TA-XT2) in a synthetic jelly at 65% SS and pH 3.0. The breaking strength is measured at a calcium level of 0 ppm Ca²⁺ (break −Ca²⁺) and 90 ppm Ca²⁺ (break +Ca²⁺).

Apparatus:

1. Balance (max. load 3-6 kg)
2. Glass beakers, (1000 ml), 2 pieces
3. Measuring flask, (1000 ml), 2 pieces
4. Magnet stirrer
5. High-speed mixer
6. Electric hotplate, diameter 15 cm, 1500 W
7. Saucepan, stainless steel, 1.5 l
8. Ladle
9. Stirrer at 500 rpm
10. Stirrer spindle (HETO, article no. 000240, drawing no. 0004259)
11. Pipette
12. Haake D-8-G thermostatically controlled water bath
13. Steel sample containers (inner diameter 50 mm, inner height 74 mm) with lids
14. Petri-dishes (bottom), diameter: 61 mm, height: 9 mm
15. Lids for petri-dishes
16. Heating cabinet at 25° C.+2° C.
17. Adhesive tape
18. Wire cheese slicer
19. Texture Analyser type TA-XT2
20. Refractometer
21. pH-meter
22. Stopwatch
23. Computer with Windows
24. Printer
25. Computer program for determination of IPPA temperature. The soft ware is available from CPKelco.

Buffer Solution No. 1 (+Ca²⁺):

| | | |
|---|---|---|
| Potassium citrate monohydrate, K₃C₆H₅O₇, | 3.933 | g |
| H₂O: | | |
| Calcium citrate tetrahydrate, Ca₃(C₆H₅O₇)₂, | 1.898 | g |
| 4H₂O: | | |
| Sodium benzoate, C₇H₅NaO₂: | 1.000 | g |
| Citric acid monohydrate, C₆H₈O₇, H₂O, | 25 | ml |
| 50% (w/v): | | (approximately) |

Dissolve in the mentioned sequence in 900 ml deionized water, add citric acid while stirring until the calcium citrate is dissolved. Adjust pH to 3.4-3.5 with citric acid and transfer quantitatively to a 1000 ml measuring flask which is filled up to the mark with deionized water.

Buffer Solution No. 2 (−Ca²⁺):

| | | |
|---|---|---|
| Potassium citrate monohydrate, K₃C₆H₅O₇, | 3.933 | g |
| H₂O: | | |
| Sodium benzoate, C₇H₅NaO₂: | 1.000 | g |
| Citric acid monohydrate, C₆H₈O₇, H₂O, | 18 | ml |
| 50% (w/v): | | (approximately) |

Dissolve as buffer solution No. 1.

Citric Acid Solution, 50% w/v:

| | |
|---|---|
| Citric acid monohydrate, C₆H₈O₇, H₂O: | 500 g |

Dissolve citric acid in deionized water and fill up with deionized water to a total of 1000 ml.

Pectin Solution:

| | | |
|---|---|---|
| Boiling water, deionized: | 380 | ml |
| Pectin (150 grade USA-SAG): | x | g |

Weigh out the water and slowly add the pectin in the high-speed mixer at speed 1. After addition the speed is increased to speed 3 for 5 min. Cool the solution to ambient temperature and weigh up to 400 g and mix in high-speed mixer. Weigh out 121 g pectin in a 250 ml glass beaker.

Calculation of x g Pectin:
(8.7×150)/(assumed USA-SAG grade)=x g

Recipe:

| Soluble solids %: | 65.0 ± 0.5 | |
|---|---|---|
| pH: | 3.0 ± 0.05 | |
| Gel +Ca²⁺: | | |
| Buffer solution No. 1: | 135 | g |
| Sugar: | 385 | g |
| Pectin solution: | 120 | g |
| Citric acid solution, approximately 50% (w/v): | 3 | ml |
| | | (suggested |
| | | quantity) |
| Total, approximately: | 643 | g |
| Evaporation, approximately: | 43 | g |
| Final yield: | 600 | g |
| Gel −Ca²⁺: | | |
| Buffer solution No. 2: | 135 | g |
| Sugar: | 385 | g |
| Pectin solution: | 120 | g |
| Citric acid solution, approximately 50% (w/v): | 2.5 | ml |
| | | (suggested |
| | | quantity) |
| Total, approximately: | 642.5 | g |
| Evaporation, approximately: | 42.5 | g |
| Final yield: | 600 | g |

Procedure:
Determination of IPPA Temperature (Developed at CP Kelco) and Preparation of Sample Solution With and Without Calcium:

1. Start the program. Use the following settings:

| | |
|---|---|
| Start temperature: | 95° C. |
| End temperature: | 15° C. |
| Temperature gradient: | 1° C./min. |
| Enter file name | |

2. Fill deionized water into a metal container and place in the Haake D-8-G thermostatically controlled water bath.
3. Place the reference sensor at the middle of the container and press START. The water bath will now heat to start temperature.
4. Weigh buffer solution into a tarred saucepan (diameter 16 cm, inner height 7.5 cm). Add sugar and start the stopwatch. Heat to boiling while stirring (500 rpm).
5. Add pectin solution from the 250 ml glass beaker (120 g) and scrape (remainder in beaker approximately 1 g) and continue boiling and stirring.
6. Continue boiling for 1 min.
7. Add calculated quantity of citric acid solution. Continue boiling and stirring for 30 seconds.
8. Weigh up to 600 g with deionized water or boil to evaporate. (In practice slightly more water may be added in order to reach correct soluble solids.)
9. Remove the saucepan from the heat and stir using a ladle. Leave for 20 seconds before removing any foam.
10. Fill two sample containers (with lids) for the Haake D-8-G thermostatically control water bath, and place the sensors at the middle of the containers. Activate the green button PRESS TO GO ON. Once the temperature difference has dropped to less than 2° C. cooling starts. Finally, the computer will calculate gelling temperature.
   Determination of Breaking Strength:
1. Fill, immediately after step 7, 3 petri-dishes (bottom part) (diameter 61 mm, height 9 mm), all equipped with tape rind.
2. Cover the petri-dishes with lids to prevent drying out of the gel on standing.
3. Leave jellies for 18-24 hours at 25° C.±2° C. before measuring breaking strength.
   Break:
1. Remove tape rind and cut the jelly top with a wire cheese slicer level with the rim of the petri-dish.

2. Measure breaking strength on TA-XT2

| | | |
|---|---|---|
| Plunger distance: | 6 | mm |
| Plunger diameter: | 12.7 | mm |
| Plunger speed: | 0.5 | mm/s |

3. State results as the averages of the three jellies with Ca²⁺ and the three jellies without Ca²⁺, respectively (break +Ca) and (break −Ca).
4. Measure soluble solids. Can be measured in IPPA temperature metal containers. Soluble solids must be 64.5-65.5%. Otherwise, the test must be repeated.
5. Measure pH. This must be 2.95-3.05. Otherwise the test must be repeated with adjusted quantity of citric acid, see appendix.
   Notes:
   Adjustment of pH if Out of Range for Analysis

The quantity of citric acid in ml may be calculated according to the following formulas if the pectin composition is known: x=pH in a 1% solution

With Calcium:

Lemon and lime pectins: 50% citric acid solution=0.0094x2+0.8926x+0.2004
Orange pectins: 50% citric acid solution=1.1364x2−6.7409x+12.775
   Without Calcium:
Lemon and lime pectins: 50% citric acid solution=0.0671x2+0.4573x+0.8023
Orange pectins: 50% citric acid solution=2.2727x2−14.482x+25.551

The citric acid quantity is suggested only. PH in the final product decides the quantity of added citric acid. The formulas for calculation of quantity of 50% citric acid solution have been generated through regression of a substantial number of samples.

Breaking Strength and IPPA Temperature at 60% SS for HM-Pectin (Rapid Set)

Principle

The breaking strength is measured on Texture Analyser (TA-XT2) in a synthetic jelly at 60% SS and pH 3.0. The breaking strength is measured at a calcium level of 0 ppm Ca²⁺ (break −Ca²⁺) and 90 ppm Ca²⁺ (break +Ca²⁺).

Apparatus:

1. Balance, max. load 3-6 kg
2. Glass beakers, (1000 ml), 2 pieces
3. Measuring flask, (1000 ml), 2 pieces
4. Magnet stirrer
5. High-speed mixer
6. Electric hotplate, diameter: 15 cm, 1500 W
7. Saucepan, stainless steel, 1.5 l
8. Stirrer at 500 rpm
9. Stirrer at 500 rpm
10. Stirrer spindle (HETO, article no. 000240, drawing no. 0004259)
11. Pipette
12. Haake D-8-G thermostatically controlled water bath
13. Steel sample containers (inner diameter 50 mm, inner height 74 mm) with lids
14. Petri-dishes (bottom), diameter: 61 mm, height: 9 mm
15. Lids for petri-dishes
16. Heating cabinet at 25° C.+2° C.
17. Adhesive tape
18. Wire cheese slicer
19. Texture Analyser type TA-XT2
20. Refractometer
21. pH-meter
22. Stopwatch
23. Computer with Windows
24. Printer
25. Computer program for determination of IPPA temperature (developed by CP Kelco)

Buffer Solution No. 1 (+Ca²⁺):

| | | |
|---|---|---|
| Potassium citrate monohydrate, K₃C₆H₅O₇, | 3.933 | g |
| H₂O: | | |
| Calcium citrate tetrahydrate, Ca₃(C₆H₅O₇)₂, | 1.898 | g |
| 4H₂O: | | |
| Sodium benzoate, C₇H₅NaO₂: | 1.000 | g |
| Citric acid monohydrate, C₆H₈O₇, H₂O, | 25 | ml |
| 50% (w/v) | | (approximately) |

Dissolve in the mentioned sequence 900 ml deionized water and transfer quantitatively to a 1000 ml measuring flask which is filled up to the mark with deionized water. Solution pH must be 3.4-3.5.

Buffer Solution No. 2 (−Ca²⁺):

| | | |
|---|---|---|
| Potassium citrate monohydrate, K₃C₆H₅O₇, | 3.933 | g |
| H₂O: | | |
| Sodium benzoate, C₇H₅NaO₂: | 1.000 | g |
| Citric acid monohydrate, C₆H₈O₇, H₂O, | 18 | ml |
| 50% (w/v): | | (approximately) |

Dissolve as No. 1.

Citric Acid Solution, 50% w/v:

| | |
|---|---|
| Citric acid monohydrate, C₆H₈O₇, H₂O: | 500 g |

Dissolve citric acid in deionized water and fill up with deionized water to a total of 1000 ml.

Pectin Solution:

| | | |
|---|---|---|
| Boiling water, deionized: | 380 | ml |
| Pectin (150 grade USA-SAG): | x | g |

Dissolve pectin in high-speed mixer for 5 minutes. Cool the solution to ambient temperature and weigh up to 400 g and mix in high-speed mixer. Weigh out 121 g pectin solution in a 250 ml glass beaker.

Calculation of x g Pectin:
(8.7×150)/(assumed USA-SAG grade)=x g

| Recipe: | | |
|---|---|---|
| Soluble solids %: | 60.0 ± 0.5 | |
| pH: | 3.0 ± 0.05 | |
| Gel +Ca²⁺: | | |
| Buffer solution No. 1: | 135 | g |
| Sugar: | 355 | g |
| Deionized water: | 30 | g |
| Pectin solution: | 120 | g |
| Citric acid solution, approximately | 3 | ml (suggested quantity) |
| 50% (w/v): | | |
| Total: | 643 | g (approximately) |
| Evaporation: | 43 | g (approximately) |
| Final yield: | 600 | g |
| Gel −Ca²⁺: | | |
| Buffer solution No. 2: | 135 | g |
| Sugar: | 355 | g |
| Deionized water: | 30 | g |
| Pectin solution: | 120 | g |
| Citric acid solution, approximately | 2.5 | ml (suggested quantity) |
| 50% (w/v): | | |
| Total: | 642.5 | g (approximately) |
| Evaporation: | 42.5 | g (approximately) |
| Final yield: | 600 | g |

Procedure:
Determination of IPPA Temperature, Which is the Gelling Temperature of the Gel Made According to the Above Composition, and Preparation of Sample Solution With and Without Calcium

1. Start the programme. Use the following settings:

| | |
|---|---|
| Start temperature: | 95° C. |
| End temperature: | 15° C. |
| Temperature gradient: | 1° C./min. |
| Enter file name | |

2. Fill deionized water into a metal container and place in the Haake D-8-G thermostatically controlled water bath.
3. Place the reference sensor at the middle of the container and press START. The water bath will now heat to start temperature.
4. Weigh buffer solution into a tarred saucepan (diameter 16 cm, inner height 7.5 cm). Add sugar and start the stopwatch. Heat to boiling while stirring (500 rpm).
5. Add pectin solution from the 250 ml glass beaker (120 g) and scrape out (remainder in the beaker approximately 1 g) and continue boiling and stirring.
6. Continue boiling for 1 minute.
7. Add calculated quantity of citric acid solution. Continue boiling and stirring for 30 seconds.
8. Weigh up to 600 g with deionized water or boil to evaporate. (In practice slightly more water may be added to reach correct soluble solids.)
9. Remove the saucepan from the heat and stir using a ladle. Leave for 20 seconds before removing any foam.
10. Fill two sample containers with lids for the Haake D-8-G thermostatically controlled water bath, and place the sensors at the middle of the containers. Activate the green button PRESS TO GO ON. Once the temperature difference has dropped to less than 2° C. cooling starts. Finally, the computer will calculate gelling temperature.
   Determination of Breaking Strength:
1. Fill, immediately after step 7, 3 petri-dishes (bottom part) (diameter 61 mm, height 9 mm), all equipped with tape rind.
2. Cover the petri-dishes with lids to prevent drying out of the gel on standing.
3. Leave jellies for 18-24 hours at 25° C.±2° C. before measuring breaking strength.
   Break:
1. Remove tape rind and cut the jelly top with a wire cheese slicer level with the rim of the petri-dish.

2. Measure breaking strength on TA-XT2

| | | |
|---|---|---|
| Plunger distance: | 6 | mm |
| Plunger diameter: | 12.7 | mm |
| Plunger speed: | 0.5 | mm/s |

3. State results as the averages of the three jellies with Ca²⁺ and the three jellies without Ca²⁺, respectively (break +Ca) and (break −Ca).
4. Measure soluble solids. Can be measured in IPPA temperature metal container. Soluble solids must be 59.5-60.5. Otherwise the test must be repeated.
5. Measure pH. This must be 2.95-3.05. Otherwise the test must be repeated with adjusted quantity of citric acid, see appendix.
   Notes:
   Adjustment of pH if Outside Range for Analysis

The quantity of citric acid in ml may be calculated according to the following formulas if the pectin composition is known: x=pH in a 1% solution.

With Calcium:

Lemon and lime pectins: 50% citric acid solution=0.0094x2+0.8926x+0.2004
Orange pectins: 50% citric acid solution=1.1364x2−6.7409x+12.775
   Without Calcium:
Lemon and lime pectins: 50% citric acid solution=0.0671x2+0.4573x+0.8023
Orange pectins: 50% citric acid solution=2.2727x2−14.482x+25.551

The citric acid quantity is suggested only. PH in the final product decides the quantity of added citric acid. The formulas for calculation of quantity of 50% citric acid solution have been generated through regression of a substantial number of samples.

Determination of the USA SAG-Degree of High Ester Pectin

Principle:

The USA SAG degree method is a method, which expresses directly the sugar binding capacity of the pectin. The method assumes a gel containing 65% soluble solids at a pH of 2.2-2.4, and that this gel sags 23.5%. The method requires that a range of gels are made containing different concentrations of pectin. For a gel, which fulfils the requirements, the ratio between pectin and sugar is calculated. If this ratio is 1:150, the pectin is 150 degrees USA SAG.

Apparatus:

1. Analytical balance
2. Laboratory scale (max. load 3-5 kg, accuracy 0.2 g)
3. Stainless steel saucepan, 1.5 l, 15 cm diameter
4. Electric hotplate, 15 cm diameter, 1500 W
5. Stirrer motor, adjustable speed, 500-1000 rpm
6. Stirrer shaft (HETO, article No. 000240, drawing No. 0004259)
7. Beakers (1000 ml and 150 ml)
8. Spatula
9. Stop watch
10. Thermometer, 100° C.
11. pH-meter
12. SAG-glasses and tape
13. Ridgelimeter
14. Wire cheese slicer
15. Refractometer
16. Incubator
   Chemicals:
Sugar
Tartaric acid (488 g per liter solution)
Deionized water
   Preparation of Jelly:
1. Weigh into 1000 ml beaker 650/(650−x) g sugar, (x=assumed firmness of pectin).
2. Transfer 20-30 g of the weighed sugar into a dry 150 ml beaker and add the weighed pectin sample (the weight of pectin to use in a jelly is expressed as: 650 g/assumed grade).
3. Mix pectin and sugar thoroughly in the beaker by stirring with spatula.
4. Pour 410 ml deionized/distilled water into the 1500 ml tarred, stainless steel saucepan and place stirrer shaft in it. Pour pectin/sugar mixture into water—all at once—while stirring at 1000 rpm. Continue stirring for two minutes. (It is important as quickly as possible to submerge the pectin/sugar solution in the water and to transfer any traces of pectin/sugar in the small beaker to the saucepan).
5. After 2 minutes, place saucepan on preheated electric hotplate, and stir at 500 rpm.
6. When contents reach a full rolling boil, add remaining sugar and continue heating and stirring until sugar is dissolved and until net weight of the jelly batch is 1015 g.
7. The electric hotplate should be set so that the entire heating time for the jelly is 5-8 minutes (full load, 1500 W).
8. After weighing the 1015 g batch on the laboratory scale, leave it undisturbed on the table for one minute. Then tip the saucepan, so that the contents are just about to overflow, and quickly skim off any foam. Place thermometer in the batch and continue stirring gently until the temperature reaches exactly 95° C.
9. Quickly pour the batch into two previously prepared SAG glasses each containing 1.75-2.25 ml of tartaric acid solution and equipped with adhesive tape allowing filling to approximately 1 cm above the brims.
10. After 15 minutes, cover the glasses with lids, and when the temperature reaches 30-35° C., place the glasses in an incubator at 25±3° C. for 20-24 hours.
   Measuring:
1. After 20-24 hours' storage of the jellies, remove lids from glasses and remove tape. Using a wire cheese slicer, cut off the top layer and discard.
2. Then carefully turn the jelly out of the glass to an inverted position on a square glass plate furnished with Ridgelimeter.
3. Start stop watch once the jelly is on the glass plate. If the jelly leans slightly to one side this can usually be corrected by gently tilting the glass plate in the other direction.
4. Place plate and jelly carefully on the base of the Ridgelimeter so that the jelly is centered under the micrometer screw, which should then be screwed down near to the surface of the jelly.
5. Two minutes after the stop watch was started, bring the point of the micrometer screw into contact with the jelly surface and record the Ridgelimeter reading to the nearest 0.1.
6. Measure pH if the SAG gel is loose or atypical by visual inspection or handling. PH must be between 2.2 and 2.4. Otherwise, the sample must be retested.
   Calculation of Jelly Grade of the Pectin:
1. Using the Ridgelimeter calibration table, convert the Ridgelimeter reading to a Factor 1 (see FIG. 1).
2. Using the soluble solids correcting table, the soluble solids measured is converted into a Factor 2 (see FIG. 2).
3. When multiplying the assumed grade of the test by the correction factors, the true grade is obtained:
   Assumed grade×Factor 1×Factor 2=true grade [image]
   Correlation Values Calculated for “Exchanged” SAG Analysis

[image]

[image]

Molecular Weight Determination for Pectin

Principle:

Molecular weight is estimated by measuring the relative viscosity of a 0.1% pectin solution using Na-hexametaphosphate.

Apparatus:

1. Witeg-Ostwald-viscosimeter or similar (min. two) with 100 to 150 sec. Outlet time for water (25° C.).
2. Transparent thermostatic water bath, 25.0° C.±0.3° C.
3. Digital stop watch.
   Reagents:
1. Na-hexametaphosphate solution:
a) 20.0 g Na-hexametaphosphate is dissolved in 1800 ml ion exchanged deaerated (boiled) water.
b) pH is adjusted to 4.50±0.05 with 1 M HCl.
c) The solution is diluted with ion exchanged, deaerated (boiled) water until 2000 ml.
   Procedure:
1. The used viscometers must be cleaned as stated in section: Cleaning/maintenance of viscometers.
2. Outlet time for hexametaphosphate solution is measured (section: Measuring of outlet time) on the viscometers used for every time a new hexametaphosphate solution is prepared and for every new working day where pectin solutions are being measured. Immediately before measuring the necessary quantity of hexametaphosphate solution is filtered through a glass filter # 3.
3. The pectin sample system for molecular weight determination is made as follows:
a) Acid wash the pectin as described in the method for determination of AGA and DE (GENU Control Method No 378).
b) Approximately 90 g hexametaphosphate solution is weighed in a tarred beaker with magnet.
c) 0.1000 g acid washed pectin is gradually added while stirring.
d) Heat the solution to 70° C. while stirring. Keep stirring until the pectin is completely dissolved.
e) Cool the solution to 25° C.
f) Weigh up to 100.0 g with hexametaphosphate solution.
g) Filter through a glass filter # 3.
4. For every molecular weight determination the outlet time is measured (section: Measuring the outlet time) for the pectin/hexametaphosphate solution on two different viscometers.
5. Molecular weight is calculated (section: Calculation) separately for each viscometer using the latest measured outlet time for hexametaphosphate solution on the viscometer in question.
6. Should the difference between two calculated molecular weights be less than 3500 the mean value is calculated. Round off the value to the nearest multiple of 1000 and that will be the result of the method.
7. Should the difference between the two calculated molecular weights be 3500 or more the viscometers should be cleaned and a new measuring of outlet time for hexametaphosphate solution should be performed.
   Measuring the Outlet Time:
1. The viscometer is rinsed twice with the sample.
2. Pour 5.00 ml of the sample in the viscometer and place it in the thermostatic water bath at 25.0° C.+0.3° C. at least 15 minutes prior to measuring.
3. Time is measured on two outlets. Should the difference between the times be more than x seconds the measuring is repeated until you have two consecutive measurements which differ no more than x seconds.
   x=0.2 seconds on measuring hexametaphosphate solution
   x=0.4 seconds on measuring samples
4. The outlet time which is needed for further calculations is the mean value of the above mentioned two or three identical or almost identical measuring results.
   Cleaning/Maintenance of Viscometers:
1. Having completed work: rinse once with ion exchanged water and then once with 1 M HCl.
2. Soaking between working days: 1 M HCl.
3. New working day before measuring: rinse twice in ion exchanged (not deaerated (boiled)) water.
4. Clogging: rinse carefully with a thin copper wire.
   Calculation:

The relative viscosity is calculated, as follows:
nᵣ={t₀−(K/t₀)}/{tₕ−(K/tₕ)},
where t₀ and tₕ are outlet times for pectin solution and hexametaphosphate solution, respectively.

The parameter K can with sufficient accuracy be fixed at 107 s² using Witeg-Ostwald-viscosimeter. Otherwise, K can be calculated as follows:
K={Q×tᵥ²}/{Q+(0.226×L×tᵥ)},
where Q=volume of viscometer bulb in cm³, L=length of capillary tube in cm and tᵥ=outlet time for water in seconds.

The molecular weight, M_{w}, of pectin is calculated as follows:
M_{w}={(nᵣ^{1/P}−1)×P}/k×C,
where P is fixed at 6 and k is fixed at 4.7·10⁻⁵ mol×g⁻¹; C is the weight percentage of pectin in the sample system—i.e. 0.1% with the numerical values inserted, one obtains:
M=1.277·106(nᵣ ⅙−1) g/mol.
Literature:
Povl E. Christensen:
Methods of Grading Pectin in Relation to the Molecular Weight (Intrinsic Viscosity) of Pectin.
Food Research, vol. 19, p. 163-171 (1954).
Christian J. B. Smit and Edwin F. Bryant:
Properties of Pectin Fractions Separated on Diethylaminoethylcellulose Columns.
Journal of Food Science, vol. 32, p. 197-199 (1967)

Determination of Degree of Esterification (DE) and Galacturonic Acid (GA) in Non-Amide Pectin

Principle:

This method pertains to the determination of % DE and % GA in pectin, which does not contain amide and acetate ester.

Apparatus:

1. Analytical balance
2. Glass beaker, 250 ml, 5 pieces
3. Measuring glass, 100 ml
4. Vacuum pump
5. Suction flask
6. Glass filter crucible no. 1 (Büchner funnel and filter paper)
7. Stop watch
8. Test tube
9. Drying cabinet at 105*C
10. Desiccator
11. Magnetic stirrer and magnets
12. Burette (10 ml, accuracy±0.05 ml)
13. Pipettes (20 ml: 2 pieces, 10 ml: 1 piece)
14. pH-meter/autoburette or phenolphtalein
   Chemicals:
1. Carbon dioxide-free water (deionized water)
2. Isopropanol (IPA), 60% and 100%
3. Hydrochloride (HCl), 0.5 N and fuming 37%
4. Sodium hydroxide (NaOH), 0.1 N (corrected to four decimals, e.g. 0.1002), 0.5 N
5. Silver nitrate (AgNO₃), 0.1 N
6. Nitric acid (HNO₃), 3 N
7. Indicator, phenolphtalein, 0.1%
   Procedure—Determination of % DE and % GA
   (Acid alcohol: 100 ml 60% IPA+5 ml HCl fuming 37%):
1. Weigh 2.0000 g pectin in a 250 ml glass beaker.
2. Add 100 ml acid alcohol and stir on a magnetic stirrer for 10 min.
3. Filtrate through a dried, weighed glass filter crucible.
4. Rinse the beaker completely with 6×15 ml acid alcohol.
5. Wash with 60% IPA until the filtrate is chloride-free* (approximately 500 ml).
   *(Chloride test: Transfer approximately 10 ml filtrate to a test tube, add approximately 3 ml 3 N HNO₃, and add a few drops of AgNO₃. The filtrate will be chloride-free if the solution is clear, otherwise there will be a precipitation of silver chloride.)
6. Wash with 20 ml 100% IPA.
7. Dry the sample for 2½ hours at 105° C.
8. Weigh the crucible after drying and cooling in desiccator.
9. Weigh accurately 0.4000 g of the sample in a 250 ml glass beaker.
10. Weigh two samples for double determination. Deviation between double determinations must max. be 1.5% absolute. If deviation exceeds 1.5% the test must be repeated.
11. Wet the pectin with approx. 2 ml 100% IPA and add approx. 100 ml carbon dioxide-free, deionized water while stirring on a magnetic stirrer.

The sample is now ready for titration, either by means of an indicator or by using a pH-meter/autoburette.

Procedure—Determination of % DE Only

(Acid alcohol: 100 ml 60% IPA+5 ml HCl filming 37%):

1. Weigh 2.00 g pectin in a 250 ml glass beaker.
2. Add 100 ml acid alcohol and stir on a magnetic stirrer for 10 min.
3. Filtrate through a Büchner funnel with filter paper.
4. Rinse the beaker with 90 ml acid alcohol.
5. Wash with 1000 ml 60% IPA.
6. Wash with approximately 30 ml 100% IPA.
7. Dry the sample for approximately 15 min. on Büchner funnel with vacuum suction.
8. Weigh approximately 0.40 g of the sample in a 250 ml glass beaker.
9. Weigh two samples for double determination. Deviation between double determinations must max. be 1.5% absolute. If deviation exceeds 1.5% the test must be repeated.
10. Wet the pectin with approximately 2 ml 100% IPA and add approx. 100 ml deionized water while stirring on a magnetic stirrer.

The sample is now ready for titration, either by means of an indicator or by using a pH-meter/autoburette.

Note: It is very important that samples with % DE<10% are titrated very slowly, as the sample will only dissolve slowly during titration.

Titration Using Indicator:

1. Add 5 drops of phenolphtalein indicator and titrate with 0.1 N NaOH until change of color (record it as V1 titer).
2. Add 20.00 ml 0.5 N NaOH while stirring. Let stand for exactly 15 min. When standing the sample must be covered with foil.
3. Add 20.00 ml 0.5 N HCl while stirring and stir until the color disappears.
4. Add 3 drops of phenolphtalein and titrate with 0.1 N NaOH until change of color (record it as V2 titer).
   Blind Test (Double Determination is Carried Out):

Add 5 drops phenolphtalein to 100 ml carbon dioxide-free or dionized water (same type as used for the sample), and titrate in a 250 ml glass beaker with 0.1 N NaOH until change of color (1-2 drops).

Add 20.00 ml 0.5 N NaOH and let the sample stand untouched for exactly 15 minutes. When standing the sample must be covered with foil.

Add 20.00 ml 0.5 N HCl and 3 drops phenolphtalein, and titrate until change of color with 0.1 N NaOH (record it as B1). Maximum amount allowed for titration is 1 ml 0.1 N NaOH. If titrating with more than 1 ml, 0.5 N HCl must be diluted with a small amount of deionized water. If the sample has shown change of color on addition of 0.5 N HCl, 0.5 N NaOH must be diluted with a small amount of carbon dioxide-free water. Maximum allowed dilution with water is such that the solutions are between 0.52 and 0.48 N.

Titration Using pH-Meter/Autoburette:

Using Autoburette type ABU 80 the following settings may be applied:

| Sample with | % DE < 10 | Blind test |
|---|---|---|
| Proportional band | 0.5 | 5 |
| Delay sec. | 50 | 5 |
| Speed - V1 | 10 | 5 |
| Speed - V2 | 15 | 5 |

1. Titrate with 0.1 N NaOH to pH 8.5 (record the result as V1 titer).
2. Add 20.00 ml 0.5 N NaOH while stirring, and let the sample stand without stirring for exactly 15 minutes. When standing the sample must be covered with foil.
3. Add 20.00 ml 0.5 N HCl while stirring and stir until pH is constant.
4. Subsequently, titrate with 0.1 N NaOH to pH 8.5 (record the result as V2 titer).
   Blind Test (Double Determination is Carried Out):
1. Titrate 100 ml carbon dioxide-free or deionized (same type as used for the sample) water to pH 8.5 with 0.1 N NaOH (1-2 drops).
2. Add 20.00 ml 0.5 N NaOH while stirring and let the blind test sample stand without stirring for exactly 15 min. When standing the sample must be covered with foil.
3. Add 20.00 ml 0.5 N HCl while stirring, and stir until pH is constant.
4. Titrate to pH 8.5 with 0.1 N NaOH (record it as B1). Maximum amount allowed for titration is 1 ml 0.1 N NaOH. If titrating with more than 1 ml, 0.5 N HCl must be diluted with a small amount of deionized water. If pH does not fall to below 8.5 on addition of 0.5 N HCl, 0.5 N NaOH must be diluted with a small amount of carbon dioxide-free water. Maximum allowed dilution with water is such that the dilutions are between 0.52 and 0.48 N.
   Calculation:
   Vₜ=V₁+(V₂−B₁)
   % DE (Degree of Esterification)={(V₂−B₁)×100}/Vₜ
   % DFA (Degree of Free Acid)=100−% DE
   % GA* (Degree of Galacturonic acid)=(194.1×Vₜ×N×100)/400
   *On ash- and moisture-free basis
194.1: Molecular weight for GA
N: Corrected normality for 0.1 N NaOH used for titration (e.g. 0.1002 N)
400: weight in mg of washed and dried sample for titration
   % Pure pectin={(acid washed, dried amount of pectin)×100}/(weighed amount of pectin)

Calcium Sensitivity—CS-99-2

Principle:

A pectin solution is adjusted to pH 3.60 using a 3.0 M Na-acetate buffer. The sample is dissolved by heating in a 75° C. water bath for 5-10 minutes. Then, 272 ppm calcium is added to the sample (above 70° C.). The sample viscosity is normally measured with a LVT Viscometer using spindle no. 1 or 2 at 60 rpm, 5° C., 19+/−3 hours later. The measuring must be performed without the protective loop.

Apparatus:

1. Viscosity glasses, 48 mm internal diameter, height 110 mm
2. Magnets, approximately 30 mm length
3. Water bath (75° C.) with magnetic stirrer
4. Foil or other heat tolerant covering material
5. 5 ml and 20 ml pipettes or dispensers
6. pH-meter
   Reagents:
1. 90-100% IPA
2. CaCl₂ solution (32 g/l CaCl₂, 2H₂O)
3. 3.0 M Na-acetate buffer.
   Buffer Preparation for 2 Liter 3.0 M Sodium Acetate Buffer pH 3.60:
1. 81.64 g Na-acetate, 3H₂O is dissolved in a beaker using approximately 1200 ml ion exchanged water.
2. The solution is transferred quantitatively to a 2000 ml measuring flask.
3. In a hood, 309 ml 100% acetic acid is added, and the measuring flask is filled to the mark with ion exchanged water.
5 liter: 204 g Na-acetate, 3H₂O, 772 ml 100% acetic acid.

PH of the solution is 3.60+/−0.05. If in doubt about the preparation check the pH.

Pectin Solution Concentration:

0.4%: weigh out 0.64 g sample (unstandardized pectin)
0.5%: weigh out 0.80 g sample (standardized pectin)
   Procedure:
1. Weigh out the sample of pectin in a viscosity glass.
2. Add 5.0 ml IPA.
3. Stir the sample at a magnetic stirrer while adding 130 ml boiling (above 85° C.) water. It is important that the viscosity glass is covered (with e. i. foil) during all agitation.
4. Add 20 ml 3.0 M Na-acetate buffer pH 3.60.
5. Stir the sample in a 75° C. water bath for minimum 5 minutes with a magnet. If the sample contains lumps the dissolving procedure must be repeated.
6. Stir the sample with vortex of approx. 2 cm. Add 5 ml calcium solution (CaCl₂, 2 H₂O, 32 g/l). Max. addition time is 2 seconds. Mix the sample for approximately 10 seconds.
   Important:

If the vortex disappears while the calcium is added—and/or local gelation or entrapped air bubbles are observed—the sample is marked pregelled as a result of the analysis. If the sample is measured later on as a normal sample the obtained result will be too low. The analysis might then be performed in a lower pectin concentration.
7. Remove the magnet and cover the glass with e.g. foil.
8. Place the sample in a 5° C. water bath for 19±3 hours. Make sure the water level of water bath is equal to the level of the sample surface.
9. If air bubbles are present at the sample surface, gently remove these prior to the sample measurement. Measure the viscosity after 1 minute at 5° C. with a LVT Viscometer, using spindle no. 2 at 60 rpm. For readings below 10 at the viscometer the measurement is performed with spindle no. 1. For meter readings above 100, place the sample at a 5° C. water bath for 19±3 hours. Then measure the viscosity using spindle no. 3 at 60 rpm.

Use the appropriate factor for calculating the viscosity (cP—centi poise). The CS value is equal to the calculated viscosity.

Clarity of a 1% Pectin Solution—Cold Solution

Principle:

The clarity of a 1% pectin solution is determined with a spectrophotometer.

Apparatus:

1. Beaker, 250 ml
2. 100% IPA
3. Magnet
4. Magnet stirrer
5. Deionized water
6. Measuring flask, 100 ml
7. Pipette
8. Spectrophotometer
   Procedure:
1. Weigh 1 g pectin into a 250 ml beaker.
2. Moisten with 3 ml IPA.
3. Place a magnet in the beaker.
4. Place the beaker on a magnet stirrer.
5. Add 96 ml deionized water while stirring.
6. Stir until the pectin is dissolved.
7. Measure the transmission or absorbance on a spectrophotometer at 655 nm.
8. State the results as % T (transmission) or % Abs (absorbance).
   Determination of Residual Sugar in Peels
   Purpose:

Determination of residual sugar in peels is done by washing with 50% isopropanol.

Apparatus:

1. Glass beaker, 600 ml
2. Balance (accuracy 0.2 g)
3. Magnet stirrer
4. Magnet
5. Paper filters (coarse) e.g. type AGF 614
6. Drying cabinet at 65-70° C.
7. Büchner funnel
8. Vacuum pump
   Solutions:
Isopropanol, 50%
   Procedure:
1. Weigh out a 10 g peel sample in 600 ml glass beaker.
2. Add 200 ml 50% isopropanol.
3. Stir for 4 hours on magnet stirrer.
4. Wash the peels and filtrate with 250 ml 50% isopropanol.
5. Place filter and sample in drying cabinet at 65-70° C. overnight and weigh.
   Calculation of Residual Sugar in Peels, %:
   {(SS×10)−(net×95)}×100/(SS×10), in which
SS=Dry matter percentage prior to washing and drying
Net=Weight of washed and dried peels
95=Set dry matter percentage on washed and dried peels

Determination of pH in HM- and LM-Pectins—Cold Solution

Principle:

pH is determined in a 1% cold prepared pectin solution.

Materials:

1. Beaker, 250 ml
2. 100% IPA
3. Magnet
4. Magnetic stirrer
5. Deionized water
6. Pipette
7. pH-meter
   Procedure:
1. Weigh out 1 g of pectin in a 250 ml beaker.
2. Moisten with 3 ml IPA.
3. Place the magnet in the beaker.
4. Place the beaker on a stirrer.
5. Add 95 g deionized water.
6. Stir until the pectin is dissolved.
7. Calibrate pH-meter with buffer solutions of pH 7.00 prepared from potassium hydrogen phthalate and disodium hydrogenphosphate; and with pH 4.01 prepared from potassium hydrogen phthalate, respectively at 25° C. Both buffers should be dissolved in water achieved through reverse osmosis followed by double ion exchange. Subsequently, measure pH in the pectin solution at 25° C.

Determination of Loss on Drying of HM- and LM-Pectin

Principle:

Loss on drying is determined by drying of a known quantity of pectin for 2 hours at 105° C. in a drying cabinet.

Apparatus:

1. Drying cabinet at 105° C.
2. Test beaker
3. Analytical balance
4. Desiccator
   Process:
1. Dry the test beaker for at least 30 minutes at 105° C. Cool the test beaker in a desiccator and weigh it.
2. Transfer a known quantity, for instance 2.000 g, of pectin to the test beaker.
3. Place the test beaker with pectin in a drying cabinet at 105° C. for 2 hours.
4. Cool the test beaker with pectin in desiccator and weigh it.
   Calculated Loss on Drying:
   % loss on drying={(g undried pectin−g dried pectin)}×100/(g undried pectin)

Determination of Plant Esterase Activity

Principle:

Hydrolysis of methyl esterase bindings in pectin under constant pH. The requirement of titrant is measured as a function of time and the activity is determined as one unit=moles demethylated carboxyl groups per minute.

Apparatus:

1. Analytical balance (accuracy 0.1 g).
2. Water bath at 5° C.
3. Stop watch.
4. pH meter.
5. Stirrer motor, adjustable, 50-2000 rpm.
6. Centrifuge.
7. Waring blender.
8. Titrator
   Chemicals and Solutions:
1. Sodium chloride, analytical grade.
2. Sodium hydroxide, analytical grade.
3. Sodium hydrogen carbonate, analytical grade.
4. Ion exchanged water with a conductivity below 1 ms/cm.
5. 0.0625 M sodium hydrogen carbonate.
6. 1 M sodium hydrogen carbonate.
   Procedure:
1. Grind the peel.
2. Weigh out 50.0 g peel and transfer it to a 2.01 plastic beaker.
3. Add ion exchanged water to a workable consistency.
4. Add sodium chloride to a concentration of 1 molar.
5. Adjust pH to 6.0 with 0.5 M sodium hydroxide.
6. Place the plastic beaker into the 5° C. water bath and stir slowly for 2 hours. Adjust pH every half hour.
7. Centrifuge the mass at 9000 rpm for 30 minutes.
8. Recover the supernatant for determination of plant esterase activity.
9. A pectin solution is made up by dissolving 20.0 g citrus pectin having a DE of 72% and 23.4 g sodium chloride in 700 ml boiling ion exchanged water by blending in a Waring blender for 3 4 minutes.
10. Cool down the pectin solution to room temperature and adjust the net weight to 1000 g.
11. Heat 100.0 g of the pectin solution to 60° C.
12. Adjust pH of the pectin solution to 5.50 with 1 M sodium hydrogen carbonate and immediately add 5 ml of the supernatant above. The amount of supernatant can be more than 5 ml or less than 5 ml depending on the actual plant esterase activity in the supernatant.
13. Begin titration with 0.0625 M sodium hydrogen carbonate and record the titration curve.
14. Determine the slope (p) of the linear part of the titration curve.
15. Calculate the plant esterase activity as Units/ml=p×62.5/ml supernatant.
   Method for the Determination of Acid Treatment on Pectin Containing Plant Starting Material:

One means of determining whether pectin containing plant starting material has been treated with acidified water is to use the following test to determine the pH of the pectin containing plant starting material. This test is of utility for pectin containing plant starting material, which inherently have a pH above 4. Examples of such pectin containing plant starting materials are orange, grape fruit, fodder beet, sugar beet, apples and carrots. For pectin containing plant starting materials that inherently have a pH of 4 or below, other means for determining whether the pectin containing plant starting material has been treated with acidified water should be used.

When testing dry peel, obtain a ten grams (10 g) sample and add the sample to a beaker. When testing a wet peel, increase the sample size to fifty grams (50 g).

Add 150 ml deionised or distilled water to the beaker.

Stir the peel/water mixture for 15 minutes using a magnetic stirring bar at ambient temperature.

After 15 minutes, measure the pH. Preferably, the pH is measured using an pH meter such as a pH M290 (available from Radiometer) equipped with a electrode such as PHC2401-8 (available from Radiometer).

For example, dried pectin containing plant starting material exhibiting a pH below 5 would be indicative of material which has been treated with acidified water, preferably the dried pectin containing plant starting material exhibiting a pH of below about 4.4, more preferably below about 4.0, still more preferably exhibiting a pH of between 4.0 and 3.5.

### EXAMPLES

The following examples are offered by way of illustration, not by way of limitation.

### Comparative Example

This example repeats the process of treating orange peel as disclosed in U.S. Pat. No. 2,387,635 (Bailey, H. S.).

8 liters of shredded orange peel (measured by displacement) were added to 4.67 liters of boiling water. An amount of 62% nitric was added to ensure a pH in the range 2.8-3.6 during the heating. It turned out, that an amount of 80 ml of 62% nitric acid provided a pH of 3.4 during heating. The relatively high amount of acid needed to reduce the pH was explained by the relatively high buffer capacity of the fresh peel and the low amount of added water. After 10 minutes, the mass was cooled and the peel was separated on a screen. The peel was then pressed using a hydraulic press, and the pressed peel was spread thinly on several drying trays and dried at 70° C. in a drying cabinet at atmospheric pressure.

500 g of the dried peel was subsequently extracted according to the method “Extraction of pectin”, and the resulting pectin was labeled Comparative Example 1.

Results:

| | | | pH of | | | | |
|---|---|---|---|---|---|---|---|
| | | HNO₃ in | extract | | | | Plant esterase |
| | Sugar | extraction | at | Precipitated | | Yield | activity |
| Sample | % | ml | 25° C. | extract g | Pecting | g/l | Unit/g |
| Comparative | 49.0 | 60 | 1.76 | 12725 | 79.20 | 6.22 | 0 |
| Example 1 | | | | | | | |

| | | | Pectin | | | | | pH | |
|---|---|---|---|---|---|---|---|---|---|
| Sample | SAG | Yield % | Purity % | DE % | GA % | M_{w} | TS % | 1% | T* % |
| Comparative | 177° | 18.7 | 97.7 | 67.9 | 78.6 | 82000 | 96.4 | 3.36 | 68.3 |
| Example 1 | | | | | | | | | |

*Transmittance

From this example it is evident that the method used in U.S. Pat. No. 2,387,635 provides an orange material with a high content of sugars. Thus, the method described in U.S. Pat. No. 2,387,635 does not provide for an efficient removal of sugars from the orange peel. In addition, with the high content of sugars in the peel, the resulting yield of pectin is low. When looking at the resulting pectin, the USA SAG is low and so is the molecular weight. This indicates that the pectin has been depolymerized during the subsequent heating of the orange peel/water suspension. Finally, this example shows that by heating the orange peel/water suspension to about 90° C., the activity of plant esterase has been completely eliminated.

### Example 1

In this example, the treatment with acid is performed at room temperature and with a higher amount of water.

8 liters of shredded orange peel (measured by replacement) were added to 24 liters of water, to which had previously been added an amount of acid to reach a pH in the peel/water mix in the range 2.8-3.6. It turned out, that an amount of 20 ml of 62% nitric acid resulted in a pH of 3.2 of the peel/water mix. The peel/water mix was stirred at room temperature for 15 minutes. After this period, the peel was separated from the liquid, and the recovered peel was pressed under slight pressure on a hydraulic press to remove excess water without crushing the peel. The pressed peel was then added to 24 liters of fresh water to which was previously added an amount of acid to reach a pH in the peel/water mix in the range 2.8-3.6. It turned out, that an amount of 15 ml 62% nitric acid resulted in a pH of 3.2 of the peel/water mix. The lower amount of acid necessary in this step is explained by the first step having removed a portion of the peel's natural acid. The peel/water mix was stirred at room temperature for 15 minutes, and the peel was then separated from the liquid. The recovered peel was pressed under slight pressure on a hydraulic press to remove excess water without crushing the peel. This last washing step was repeated, after which the recovered and pressed peel was spread thinly on several trays and dried at 70° C. in a drying cabinet at atmospheric pressure.

500 g of the dried peel was subsequently extracted according to the method “Extraction of pectin”, and the resulting pectin was labeled Example 1.

Results:

| | | | pH of | | | | |
|---|---|---|---|---|---|---|---|
| | | HNO₃ in | extract | | | | Plant esterase |
| | | extraction | at | Precipitated | | Yield | activity |
| Sample | Sugar % | ml | 25° C. | extract g | Pectin g | g/l | Unit/g |
| Example 1 | 16.8 | 60 | 1.74 | 8300 | 82.60 | 9.95 | 42 |

| | | | Pectin | | | | | pH | |
|---|---|---|---|---|---|---|---|---|---|
| Sample | SAG | Yield % | Purity % | DE % | GA % | M_{w} | TS % | 1% | T* % |
| Example 1 | 213° | 29.9 | 94.9 | 63.7 | 83.2 | 101000 | 96.3 | 3.34 | 87.5 |

*Transmittance

This example shows, that when applying the method of the present invention, less sugar remains in the acid washed peel, and consequently, the yield of pectin is increased dramatically. Further, The wash with acidified water brings about an increase in both USA SAG and in molecular weight compared to the comparative example. In fact, the ratio of USA SAG of example 1 compared to the comparative example's USA SAG is 1.20. Thus, by treating the orange peel according to the present invention, a 20% increase in USA SAG is achieved. Correspondingly, the ratio between the molecular weight of the pectin resulting from example 1 and the pectin resulting from the comparative example is 1.23. Thus, the molecular weight is increased by 23% when the orange peel is treated according to the present invention.

### Example 2

In this example, the comparative example was repeated with fresh oranges directly picked from an orange tree. However, this example used steam instead of boiling water. The procedure was the same as in example 1. However, after thrice washing with acidified water, the lightly pressed peel residue was placed on a Bücher funnel. To the outlet of the Bücher funnel a tube was fitted, and steam was then injected into the peel through the tube. The steaming continued for 3 minutes. With a thermo couple, the temperature inside the peel was measured, and it turned out, that a temperature of 90° C. was achieved after 2 minutes of steaming. After steaming, the peel was further processed as in example 1. The resulting pectin was labeled “D”.

Results:

| | | | | Break strength | | |
|---|---|---|---|---|---|---|
| | | | | Break | Break | |
| Sample | M_{w} | SAG | DE % | −Ca | +Ca | +Ca/−Ca |
| “D” | 93800 | 205° | 66 | 195 | 201 | 1.03 |

With completely fresh orange peel, the USA SAG was about 16% higher than in the comparative example. Similarly, the molecular weight was about 14% higher.

### Example 3

This example is based on example 1 with the exception that the orange peel used was the orange peel from example 2. Thus, the treatment was performed at room temperature, washing three times at pH 3.5, followed by a drying. The dry peel was extracted in the same way as in examples 1 and 2.

Results:

| | | | | Break strength | | |
|---|---|---|---|---|---|---|
| | | | | Break | Break | |
| Sample | M_{w} | SAG | DE % | −Ca | +Ca | +Ca/−Ca |
| “C” | 116900 | 229° | 68 | 156 | 185 | 1.19 |

This example shows that washing with acidified water brings about an increase in both USA SAG and in molecular weight compared to the comparative example. In fact, the ratio of USA SAG of example 3 compared to the example 2 is 1.12. Thus, by treating the orange peel according to the present invention, a 12% increase in USA SAG is achieved. Correspondingly, the ratio between the molecular weight of the pectin resulting from example 3 and the pectin resulting from example 2 is 1.25. Thus, the molecular weight is increased by 25% when the orange peel is treated according to the present invention. So, independent of the freshness of the orange fruit, the present invention provides a substantial increase in both USA SAG and molecular weight of the resulting pectin.

### Example 4

The present invention was scaled up 1000 fold and the process run for several days. Thus, the fresh peel was washed in a 4-step countercurrent process with water. The resulting pH of the comparative examples varied between 4.5 and 5.2. For acid wash, the pH was adjusted to 3.4-3.6. The treatment was at 30 degrees C. After washing, the peel was dried continuously.

Samples were taken during the trial, and these samples were extracted after the recipe used in example 1.

Results:

Break strength

| Treatment | SAG | −Ca | +Ca | +Ca/−Ca |
|---|---|---|---|---|
| Fresh water | 228° | 151 | 121 | 0.80 |
| (Comparative) | | | | |
| Fresh water | 232° | 180 | 131 | 0.73 |
| (Comparative) | | | | |
| Fresh water | 234° | 133 | 110 | 0.83 |
| (Comparative) | | | | |
| Acid wash | 240° | 151 | 143 | 0.95 |
| (Example) | | | | |
| Acid wash | 235° | 254 | 239 | 0.94 |
| (Example) | | | | |
| Acid wash | 224° | 171 | 168 | 0.98 |
| (Example) | | | | |
| Acid wash | 228° | 239 | 246 | 1.03 |
| (Example) | | | | |
| Acid wash | 235° | 202 | 193 | 0.96 |
| (Example) | | | | |
| Acid wash | 238° | 184 | 209 | 1.14 |
| (Example) | | | | |

When using fresh water or acidified water, the SAG values are not significantly different. However, looking at the ratio between the break strengths made with and without addition of calcium, the fresh water treated peels, produce pectin with a ratio below 0.83. The peel washed with acidified water produce pectin with said ratio above 0.94. This shows that the peel treated with acidified water results in pectin of a substantial lower calcium sensitivity. In fact, the calcium containing gels made from the pectin resulting from a wash of the peel in fresh water showed clear evidence of pre-gelation, whereas this phenomenon was not observed in the corresponding gels made out of pectin having been washed with acidified water.

### Example 5

This example is presented to demonstrate the effect of acidified water washing temperature on the dried peel and the resultant pectin.

Approximately 25 kg of fresh orange peel was used. The peel was chopped and treated as detailed below.

In comparative example 5, one third of the peel was washed 3 times without acid. The pH of the wash water was measured to pH 5.18.

The remainder of the peel was treated with acidified water in which the last stage of the mixture was heated to various temperatures.

Acidified Water Wash

The peel was stirred for 15 minutes at room temperature, with “3 volumes” of water. The pH was adjusted to 3.5 by nitric acid and then the peel was separated on a “drying tray”. Care was taken to add the acid to the water prior to adding the peel.

The peel was lightly pressed on a hydraulic press to remove the excess acidified water. Care was taken to avoid crushing the peel.

The peel was recharged into a second lot of 3 volumes of water and the pH was adjusted to 3.5. The peel acidified water mixture was stirred for an additional 15 minutes. The peel was separated on a drying tray.

The peel was pressed as in the previous step.

The peel was divided into two (2) equally sized portions

The procedure was repeated for a third time with 3 volumes of water and the pH was adjusted to 3.5. The pH was recorded before separation of the peel on a drying tray. In the third and final acidified water washing stage, various temperatures were used. Example 5a was washed at 25° C. Example 5b was washed at 65° C.

All examples of the peel were pressed using a hydraulic press to remove the excess water. The pressed treated peel was spread on several drying trays. The pressed treated peel was then dried in a drying cabinet at approximately 70° C. and with sufficient airflow overnight (approximately 15 hours) until it was considered “dry”.

TABLE 5.1

| | Water | | pH of |
|---|---|---|---|
| Example | (L) | pH | Peel |
| Comp Ex 5 | 60 | 5.18 | 6.25 |
| Example 5a | 30 | 3.45 | 3.94 |
| Example 5b | 30 | 3.47 | 3.76 |

All samples were extracted using modified standard HM pectin extraction in 50-liter vessels: (2.5 hrs, 75° C., 1000 gram peel, 40 liter water, pH 1.9-2.1).

After extraction, the samples were filtered over diatomaceous earth, ion exchanged using 50 ml resin (Amberlite SR1L from Rohm&Haas) per liter of juice, and precipitated 1:3 in 80% IPA, followed by a wash in 60% IPA.

Results:

TABLE 5.2

| | | pH | Wt | | |
|---|---|---|---|---|---|
| | | Ext. | Precipitated | Wt | |
| | HNO₃ | juice | juice | Pectin | Yield |
| Example | (ml) | 25° C. | (g) | (g) | (g/L*) |
| Comp ex 5 | 80 | 2.06 | 10000 | 42 | 4.2 |
| Example 5a | 55 | 2.12 | 10000 | 41 | 4.1 |
| Example 5b | 55 | 2.07 | 10000 | 51 | 5.1 |

*On diluted juice.

TABLE 5.3

| | | % | % | 1% | | CS-99 |
|---|---|---|---|---|---|---|
| Example | SAG | DE | GA | visc | M_{w} | +Ca |
| Comp ex 5 | 198 | 73.1 | 78.9 | 60 | 125203 | 270 |
| Example 5a | 214 | 74.2 | 79.0 | 52 | 146381 | 24 |
| Example 5b | 211 | 73.2 | 77.5 | 53 | 141683 | 27 |

This example demonstrates that the method of the present invention may be performed at temperatures from ambient to at least 65° C. That preserves a low CS, without changing the SAG.

### Example 6

The procedure of example 5 was repeated.

In comparative example 6, one third of the peel was washed 3 times without acid. The pH of the wash water was measured to pH 4.89.

In example 6a, the final acidified water wash was conducted at 25° C. In example 6b, the final acidified water wash was conducted at 70° C.

TABLE 6.1

| | Water | | pH of |
|---|---|---|---|
| Example | (L) | pH | Peel |
| Comp Ex 6 | 60 | 4.89 | 5.21 |
| Example 6a | 30 | 3.75 | 3.98 |
| Example 6b | 30 | 3.72 | 3.91 |

Results:

TABLE 6.2

| | | pH | Wt | | |
|---|---|---|---|---|---|
| | | Ext. | Precipitated | Wt | |
| | HNO₃ | juice | juice | Pectin | Yield |
| Example | (ml) | 25° C. | (g) | (g) | (g/L*) |
| Comp ex 6 | 80 | 2.04 | 10000 | 37 | 3.7 |
| Example 6a | 55 | 2.06 | 10000 | 52 | 5.2 |
| Example 6b | 55 | 1.93 | 10000 | 56 | 5.6 |

*On diluted juice.

TABLE 6.3

| | | % | % | 1% | | CS-99 |
|---|---|---|---|---|---|---|
| Example | SAG | DE | GA | visc | M_{w} | +Ca |
| Comp ex 6 | 193 | 74.2 | 81.1 | 122 | 112751 | 285 |
| Example 6a | 212 | 74.4 | 80.3 | 91 | 140340 | 52 |
| Example 6b | 204 | 73.9 | 80.1 | 87 | 135520 | 68 |

This example demonstrates that the method of the present invention may be performed at temperatures from ambient to at least 70° C. That preserves a low CS, without changing the SAG.

### Example 7

This example is presented to demonstrate the effect of acidified water washing on the dried peel and the resultant pectin produced from a citrus fruit other than orange, namely grapefruit.

Approximately 30 kg of fresh grapefruit were juiced and the peel was chopped as in example 5.

In comparative example 7, the chopped peel is stirred with “3 volumes” of water for 15 minutes at room temperature. The pH of the water was recorded after the 15 minutes of stirring, and the peel was separated onto a drying tray.

The peel was lightly pressed on a hydraulic press to remove the excess water. Care was taken to avoid crushing the peel.

The peel was recharged into a second lot of 3 volumes of water and stirred for an additional 15 minutes at room temperature. The pH of the water was recorded after the 15 minutes of stirring, and the peel was separated onto a drying tray.

This washing step was repeated for a third time.

The pressed treated peel was then dried in a drying cabinet at approximately 70° C. and with sufficient airflow overnight (approximately 15 hours) until it was considered “dry”.

Acidified Water Wash

In example 7, the peel was treated as in comparative example 7 except that the peel was washed with acidified water containing 9 ml of 62% HNO3 at a pH of from 3.5 to 3.8. Care was taken to add the acid to the water before the peel was added in order to ensure that the peel was not exposed to concentrated acid.

TABLE 7.1

| | | | | Wt |
|---|---|---|---|---|
| | Water | HNO₃ | | Peel |
| Example | (L) | (ml) | pH | (g) |
| Comp ex 7 | | | | |
| 1^{st} wash | 22 | — | ˜4.2 | — |
| 2^{nd} wash | 22 | — | ˜5.7 | — |
| 3^{rd} wash | 22 | — | ˜6.2 | 523 |
| Example 7 | | | | |
| 1^{st} wash | 22 | 9 + 2 | ˜3.6 | — |
| 2^{nd} wash | 22 | 8 + 3 | ˜3.6 | — |
| 3^{rd} wash | 22 | 11 + 1 | ˜3.5 | 601 |

All examples of the dried peel were extracted using the following pectin extraction method.

Into a small extractor, 15 L of water at 70° C. was charged. Five hundred grams (500 g) of dried peel were then added to the extractor and the pH of the water was adjusted to 1.7 by addition of 62% HNO₃.

Additional acid may be added to the extractor after 15 minutes if needed to maintain the pH. The extraction is maintained at a temperature of 70° C. and pH 1.7 for 7 hours.

After extraction, the samples were filtered over diatomaceous earth, ion exchanged using 50 ml resin (Amberlite SR1L from Rohm&Haas) per liter of juice, and precipitated 1:3 in 80% IPA, followed by a wash in 60% IPA. The resultant pectin is dried in a drying cabinet and the weigh of the resultant pectin is determined.

Results:

TABLE 7.2

| | | | pH | | | | | |
|---|---|---|---|---|---|---|---|---|
| | | | juice | | Wt | | | |
| | | pH | 25° C. | Viscosity | Precipitated | Wt | | Filtration |
| | HNO₃ | juice | after | 70° C. | juice | Pectin | Yield | Time |
| Example | (ml) | 25° C. | 1 H ext. | cp | (g) | (g) | (g/L) | (min.) |
| Comp | 60 | 1.69 | 1.69 | 4.0 | 4530 | 23.17 | 6.8 | 40 |
| ex 7 | | | | | | | | |
| Example 7 | 52 | 1.68 | 1.68 | 6.5 | 4705 | 28.23 | 8.0 | 40 |

TABLE 7.3

| | | | | | | | | | | CS- |
|---|---|---|---|---|---|---|---|---|---|---|
| | % | | % | % | | | 1% | | CS-99 − | 99 + |
| Example | Yield | % R | DE | GA | M_{W} | SAG | pH | 1% T | Ca | Ca |
| Comp ex 7 | 20.5 | 98.2 | 60.7 | 86.2 | 99 | 220° | 3.40 | 80.6 | 16.0 | 675.0 |
| Example 7 | 24.0 | 98.0 | 66.7 | 85.8 | 125 | 241° | 3.46 | 84.1 | 18.5 | 342.5 |

This example demonstrates the improvement in the pectin obtained from treated dried grapefruit peel when compared to the pectin obtained from untreated dried grapefruit peel.

### Example 8

This example is presented to demonstrate the effect of acidified water washing on the dried peel and the resultant pectin produced from a fruit other than citrus, namely apple.

Fifty (50) kg of apples (Belle de Boskoop) were obtained.

Peel from the apples was prepared as in Example 7.

TABLE 8.1

| | wet peel | | HNO₃ ml. | HNO₃ ml. | HNO₃ ml. | dry peel |
|---|---|---|---|---|---|---|
| Example | (kg) | Water (L) | wash 1/pH | wash 2/pH | wash3/pH | (kg) |
| Comp Ex 8 | 15.7 | 45 | —/3.63 | —/6.13 | —/6.88 | 0.465 |
| Example 8 | 16.5 | 50 | 0 ml./3.81* | 22 ml./3.78 | 22 ml./3.79 | 0.564 |

The samples were extracted using modified standard HM pectin extraction in 18 liter vessels: (7 hrs, 70° C., 450 gram peel, 13.5 liter water, acid as described)

After extraction, the samples were filtered over diatomaceous earth, ion exchanged using 50 ml resin (Amberlite SR1L from Rohm&Haas) per liter of juice, and precipitated 1:3 in 80% IPA, followed by a wash in 60% IPA.

Results:

TABLE 8.2

| | | | pH | Wt Precipitated | | |
|---|---|---|---|---|---|---|
| | HNO₃ | | Ext. juice | juice | Wt Pectin | |
| Example | (ml) | Sugar % | 25° C. | (g) | (g) | Yield (g/L*) |
| Comp Ex 8 | 60 | 1.80 | 1.75 | 4540 | 16.76 | 3.6 |
| Example 8 | 49 | 2.02 | 1.75 | 7170 | 31.03 | 4.3 |

TABLE 8.3

| | | | | | | | | CS- | CS- | | | |
|---|---|---|---|---|---|---|---|---|---|---|---|---|
| | | | % | % | | % | 1% | 99 − | 99 + | BS + | BS − | |
| Ex. | SAG | % R | DE | GA | M_{W} | TS | pH | Ca | Ca | Ca | Ca | % T |
| Comp | 176° | 96.2 | 64.7 | 80.3 | 149316 | 96.7 | 2.96 | 12 | 105 | *— | *— | 64 |
| Ex. 8 | | | | | | | | | | | | |
| Ex. 8 | 192° | 98.4 | 65.8 | 83.2 | 165436 | 98.1 | 2.89 | 15 | 34 | *107 | *92 | 68 |

This example demonstrates the improvement in the pectin obtained from treated dried apple peel when compared to the pectin obtained from untreated dried apple peel. The result is high M_{w}, higher SAG and lower CS.

### Example 9

In this example, example 1 was repeated in the plant, i.e. example 1 was scaled up 1000 fold. One batch was treated according to example 1 with acid, whereas another batch was treated according to example 1, however, without washing with acid. The subsequently dried batched of peel were measured according to “Method for the determination of acid treatment on pectin containing plant starting material”. In addition, the activity of plant esterase was determined on both batches according to the method, “Determination of plant esterase activity”.

Results

| | | Plant esterase acivity |
|---|---|---|
| Sample | pH of peel | Unit/g |
| Acid treated | 4.03 | 41 |
| Non-acid treated | 4.44 | 15 |

| | | | | CS-99 + | BS + | BS − | BS + Ca/ |
|---|---|---|---|---|---|---|---|
| Sample | ^{o}SAG | DE % | GA % | Ca | Ca | Ca | BS − Ca |
| Acid | 226 | 64.3 | 83.9 | 17 | 118 | 121 | 0.98 |
| treated | | | | | | | |
| Non- | 227 | 65.3 | 82.1 | 72 | 103 | 143 | 0.72 |
| acid | | | | | | | |
| treated | | | | | | | |

This example shows that the enzyme activity in the orange peel is preserved during an acid treatment according to the present invention.

Furthermore, this example shows that acid treatment according to the present invention results in a pectin derived from the acid treated orange peel, which is substantially less calcium sensitive than the pectin derived from the same orange peel that has not been treated with acid.

The lower calcium sensitivity is further illustrated by the fact, that an acid treatment results in a higher ratio between the break strength of a gel made with the addition of calcium ions, compared to the break strength of a gel made without addition of calcium ions.

Although the foregoing invention has been described in detail for purposes of clarity of understanding, it will be obvious that certain modifications may be practiced within the scope of the appended claims.

1. A method for controlling pectin esterase activity in a pectin containing plant starting material wherein said plant starting material is a fruit starting material before extraction of pectin from said pectin containing plant starting material comprising the steps of: obtaining a pectin containing plant starting material, contacting said pectin containing plant starting material with an acidified water having a pH of about 3.2 to about 3.9 at a temperature of ≦70° C. and recovering a treated pectin containing plant starting material.

2. The method of claim 1, wherein the acidified water has a pH of about 3.4 to about 3.7.

3. The method of claim 1, wherein the acidified water is acidified using an inorganic or organic acid.

4. The method of claim 1, wherein the acidified water is acidified using an inorganic acid selected from hydrochloric acid, sulfuric acid, sulfur dioxide, and nitric acid.

5. The method of claim 1, wherein the acidified water is acidified using an organic acid selected from the group consisting of citric acid, oxalic acid and acetic acid.

6. The method of claim 1, wherein the acidified water is acidified using a buffer system being capable of maintaining the pH of the acidified water within the range of about 3.2 to about 3.9.

7. The method of claim 5, wherein the buffer solution is capable of maintaining the pH of the acidified water within the range of about 3.4 to about 3.7.

8. The method of claim 6, wherein the buffering system is selected from the group comprising hydrochloric acid/disodium hydrogen-citrate, glycine/hydrochloric acid, potassium hydrogen phthalate/hydrochloric acid, citric acid/sodium citrate, and sodium acetate/acetic acid.

9. The method of claim 1, wherein said pectin containing plant starting material is contacted with an acidified water at a temperature of <50° C.

10. The method of claim 9, wherein said pectin containing plant starting material is contacted with an acidified water at a temperature of <30° C.

11. The method of claim 1, further comprising the step of drying the treated pectin containing pectin containing plant starting material to produce a dried treated pectin containing pectin containing plant starting material.

12. The method according to claim 1, wherein the pectin containing plant starting material is selected from the group consisting of citrus fruits and apples.

13. The method according to claim 1, wherein the pectin containing plant starting material comprises citrus fruits.

14. The method according to claim 13, wherein the pectin containing plant starting material comprises orange.

15. The method according to claim 12, wherein the pectin containing plant starting material comprises apples.

16. A treated pectin containing plant starting material made according to claim 1 for use in extraction of pectin.

17. The treated pectin containing plant starting material of claim 16, wherein the treated pectin containing plant starting material exhibits a pH of below about 4.5 when extracted with deionized water.

18. The treated pectin containing plant starting material of claim 17, wherein the treated pectin containing plant starting material exhibits a pH of below about 4.0 when extracted with deionized water.

19. The treated pectin containing plant starting material of claim 18, wherein the treated pectin containing plant starting material exhibits a pH of between about 4.0 and about 3.5 when extracted with deionized water.

20. The treated pectin containing plant starting material of claim 16, wherein the treated pectin containing plant starting material comprises citrus peel.

21. The treated pectin containing plant starting material of claim 20, wherein the treated pectin containing plant starting material comprises dried citrus peel.

22. The treated pectin containing plant starting material of claim 21, wherein the treated pectin containing plant starting material comprises dried orange peel.

23. A treated pectin containing plant starting material made according to claim 1 for use as animal feed.

24. A treated pectin containing plant starting material made according to claim 1 for use as an ingredient in foodstuffs.

25. A pectin, characterized by the molecular weight of said pectin being up to 50% higher than the molecular weight of a pectin obtained from extracting a similar but non-treated pectin containing plant starting material, obtainable by extraction from a pectin containing plant starting material treated by the method according to claim 1.

26. The pectin according to claim 25, characterized by the molecular weight of said pectin being about 10 to about 40% higher than the molecular weight of a pectin obtained from extracting a similar but non treated pectin containing plant starting material.

27. The pectin according to claim 26, characterized by the molecular weight of said pectin being about 15 to about 30% higher than the molecular weight of a pectin obtained from extracting a similar but non treated pectin containing plant starting material.

28. A pectin, characterized by a ratio between the calcium sensitivity of said pectin and the calcium sensitivity of a pectin extracted from a similar, but non-treated washed pectin containing plant starting material in the range 0.90-1.40, obtainable by extraction from a pectin containing plant starting material treated by the method according to claim 1.

29. The pectin according to claim 28, characterized by a ratio between the calcium sensitivity of said pectin and the calcium sensitivity of a pectin extracted from a similar, but non-treated pectin containing plant starting material in the range of about 0.90 about 1.20.

30. The pectin according to claim 29, characterized by a ratio between the calcium sensitivity of said pectin and the calcium sensitivity of a pectin extracted from a similar, but non-treated pectin containing plant starting material in the range of about 0.90 about 1.20.
